(19) United States
(12) Patent Application Publication
(10) Pub. No.: US 2015/0152952 A1
(43) Pub. Date: Jun. 4, 2015

(54) DIFFERENTIAL GEAR FOR VEHICLE

(71) Applicants: Hideaki Miyazono, Kasugai-shi (JP); Nobuharu Imai, Toyota-shi (JP)

(72) Inventors: Hideaki Miyazono, Kasugai-shi (JP); Nobuharu Imai, Toyota-shi (JP)

(73) Assignee: TOYOTA JIDOSHA KABUSHIKI KAISHA, Toyota-shi, Aichi (JP)

(21) Appl. No.: 14/414,274

(22) PCT Filed: Jul. 25, 2012
(86) PCT No.: PCT/JP2012/068891

§ 371 Date: Jan. 12, 2015

(51) Int. Cl. F16H 48/38; B60B 35/16; F16H 48/08

(52) U.S. Cl. CPC F16H 48/38; F16H 48/08; B60B 35/16; F16H 2048/387; B60B 2900/331; B60B 2900/711

(57) ABSTRACT

A vehicle differential gear device comprises: a differential case; a side gear rot at ably supported in the differential case; a drive shaft engaged with the side gear as a separate body from the side gear; a disk spring disposed between the differential case and the side gear; and a collision shock-absorbing portion between the side gear and the differential case, the side gear moves in a direction approaching the differential case, the side gear elastically deforms the disk spring, the collision shock-absorbing portion causes a force to act in a direction separating the side gear and the differential case from each other after the disk spring starts deforming.

### TECHNICAL FIELD

The present invention relates to a vehicle differential gear device for distributing power to a pair of left and right drive wheels of a vehicle and particularly to a technique of eliminating a possibility of slip-out of an axle non-rotatably fit into a side gear.

### BACKGROUND ART

A vehicle is known that includes a vehicle differential gear device that includes a differential case rotationally driven around a first axial center, a pinion rotatably supported around a second axial center orthogonal to the first axial center in the differential case, and a pair of side gears arranged relatively rotatably around the first axial center across the pinion in the differential case and meshing with the pinion and that distributes power, which is input from a drive force source to the differential case, to left and right drive wheels via a pair of axles having axial ends non-rotatably fit into the pair of the side gears. As described in Patent Documents 1 to 3, one type of the vehicle differential gear device is proposed that has an annular disk spring inserted in a pressurized state between a back surface of the side gear and a receiving surface of the differential case receiving the back surface of the side gear. Since a differential limiting force is acquired from a simple configuration and a backlash is reduced in a meshing portion between the side gear and the pinion to suppress occurrence of rattling noise if a transmission torque is relatively low, while the disk spring deforms to allow the side gear to escape in the rotation axial center direction if an excessive transmission torque acts thereon, this is advantageous in that the side gear is prevented from being damaged due to an impulsive input.

### PRIOR ART DOCUMENT

### Patent Documents

Patent Document 1: Japanese Laid-Open Patent Publication No. 08-049758

Patent Document 2: Japanese Laid-Open Patent Publication No. 08-028656

Patent Document 3: Japanese Laid-Open Patent Publication No. 10-246308

### SUMMARY OF THE INVENTION

### Problem to be Solved by the Invention

While a backlash between a side gear and a pinion is put into a zero state by the disk spring inserted in a pressurized state in the conventional vehicle differential gear device as described above, if a large impulsive torque is transmitted from the pinion to the side gear as in, for example, when drive wheels of a vehicle running on a rough road land on the ground after temporary idling, the side gear moves together with an axle. The disk spring may be brought into close contact between the side gear and the differential case, resulting in a collision between the side gear and the differential case via the disk spring. In this case, if the inertial force of the axle exceeds a slip-out load of a snap ring, the snap ring fit to an axial end of the axle for preventing slip-out from the side gear may possibly drop off from the axle.

The present invention was conceived in view of the situations and it is therefore an object of the present invention to provide a vehicle differential gear device configured to preferably prevent the possibility that an axle slips out from a side gear and the possibility that a snap ring drops off.

As a result of various studies in view of the situations, the present inventors discovered that when a local convex portion is formed on a disk spring, or a shim overlapped therewith, inserted between a back surface of a side gear and a differential case, this preferably eliminates a drop-off of a snap ring fit to an axial end of an axle and a slip-out of the axle from the side gear even if a transmission torque is suddenly applied from the pinion to the side gear and the side gear moves in a direction toward the differential case and hits the differential case due to a collision between the side gear and the pinion in the conventional vehicle differential gear device. The present invention was conceived based on such knowledge.

### Means for Solving the Problem

To achieve the object, the first aspect of the invention provides a vehicle differential gear device comprising: (a) a differential case; (b) a side gear rotatably supported in the differential case; (c) a drive shaft engaged with the side gear as a separate body from the side gear; (d) a disk spring disposed between the differential case and the side gear; and (e) a collision shock-absorbing portion between the side gear and the differential case, (f) the side gear moving in a direction approaching the differential case, the side gear elastically deforming the disk spring, (g) the collision shock-absorbing portion causing a force to act in a direction separating the side gear and the differential case from each other after the disk spring starts deforming.

To achieve the object, the second aspect of the invention provides (a) a vehicle differential gear device comprising: a differential case rotationally driven around a first axial center; a pinion rotatably supported around a second axial center orthogonal to the first axial center in the differential case; and a pair of side gears arranged relatively rotatably around the first axial center and across the pinion in the differential case and meshing with the pinion, the vehicle differential gear device distributing a power, which is input from a drive force source to the differential case, to drive wheels via a pair of axles having axial ends non-rotatably fit into the pair of the side gears, (b) an annular disk spring in a pressurized state, or the annular disk spring in a pressurized state and an annular shim in an overlapped state, being inserted between a back surface of the side gear and a receiving surface of the differential case receiving the back surface of the side gear, (c) at least one of the disk spring and the shim being disposed with a collision shock-absorbing portion alleviating a collision load between the differential case and the side gear in an axial center direction of the side gear.

### Effects of the Invention

According to the vehicle differential gear device of the first aspect of the invention, a vehicle differential gear device comprising: (a) a differential case; (b) a side gear rotatably supported in the differential case; (c) a drive shaft engaged with the side gear as a separate body from the side gear; (d) a disk spring disposed between the differential case and the side gear; and (e) a collision shock-absorbing portion between the side gear and the differential case, (f) the side gear moving in a direction approaching the differential case, the side gear elastically deforming the disk spring, (g) the collision shock-absorbing portion causing a force to act in a direction separating the side gear and the differential case from each other after the disk spring starts deforming. Therefore, even if a large impulsive torque is input from the pinion to the side gear and the side gear collides with the differential case via the disk spring, the collision shock-absorbing portion causes a force to act in a direction separating the side gear and the differential case from each other after the start of deformation of the disk spring so that the impulsive load of the collision is alleviated and, thus, the inertia of the drive shaft moving together with the side gear is reduced to preferably prevent the possibility that the drive shaft slips out from the side gear and the possibility that the snap ring drops off.

According to the vehicle differential gear device of the second aspect of the invention, (h) an annular disk spring in a pressurized state, or the annular disk spring in a pressurized state and an annular shim in an overlapped state, being inserted between a back surface of the side gear and a receiving surface of the differential case receiving the back surface of the side gear, (c) at least one of the disk spring and the shim being disposed with a collision shock-absorbing portion alleviating a collision load between the differential case and the side gear in an axial center direction of the side gear. Therefore, even if a large impulsive torque is input from the pinion to the side gear and the side gear collides with the differential case via the disk spring, or the disk spring and the shim, the collision shock-absorbing portion disposed on at least one of the disk spring and the shim alleviates the impulsive load from the collision and, thus, the inertia of the drive shaft moving together with the side gear is reduced to preferably prevent the possibility that the drive shaft slips out from the side gear and the possibility that the snap ring drops off.

Preferably, the collision shock-absorbing portion is a convex portion formed on the disk spring. Therefore, when the side gear collides with the differential case via the disk spring, the convex portion formed on the disk spring elastically deforms and makes the collision time at the collision relatively longer as compared to the case of using the conventional disk spring without the convex portion and, therefore, the maximum impulsive load of the collision is reduced as compared to the conventional case.

Preferably, the collision shock-absorbing portion in the vehicle differential gear device recited in the second aspect of the invention is a convex portion formed on the shim. Therefore, when the side gear collides with the differential case via the disk spring and the shim, the convex portion formed on the shim elastically deforms and makes the collision time at the collision relatively longer as compared to the case of using the conventional shim without the convex portion and, therefore, the maximum impulsive load of the collision is reduced as compared to the conventional case.

Preferably, in the vehicle differential gear device recited in the first aspect of the invention, (a) a shim between the disk spring and the differential case is further comprised, and (b) the collision shock-absorbing portion is a convex portion disposed on the shim. Therefore, when the side gear collides with the differential case via the disk spring and the shim, the convex portion formed on the shim elastically deforms and makes the collision time at the collision relatively longer as compared to the case of using the conventional shim without the convex portion and, therefore, the maximum impulsive load of the collision is reduced as compared to the conventional case.

### BRIEF DESCRIPTION OF THE DRAWNINGS

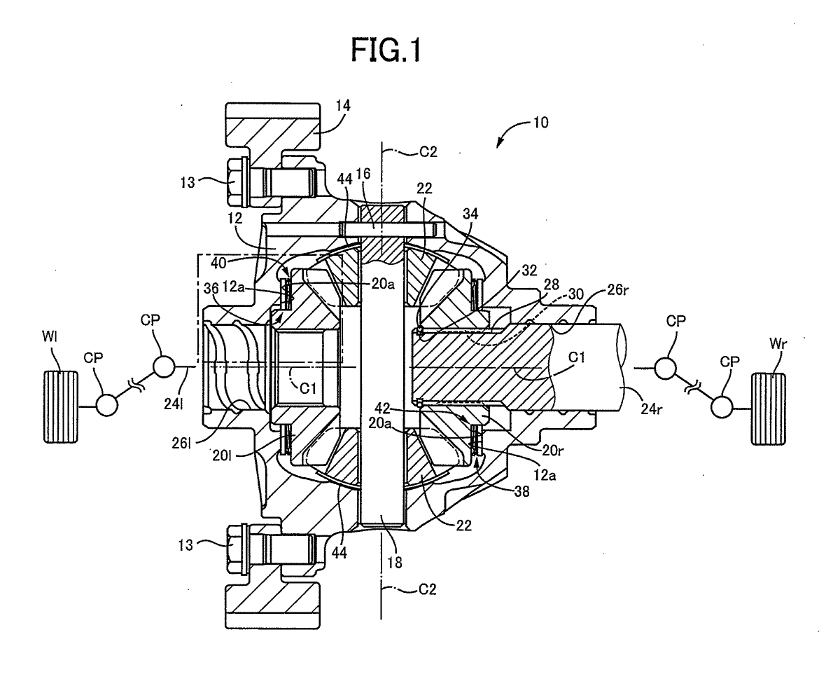

FIG. 1 is a diagram for explaining a configuration of a vehicle differential gear device to which the present invention is applied, and is a cross-sectional view acquired by cutting on a plane including an axial center of a pinion shaft and an axial center of axles.

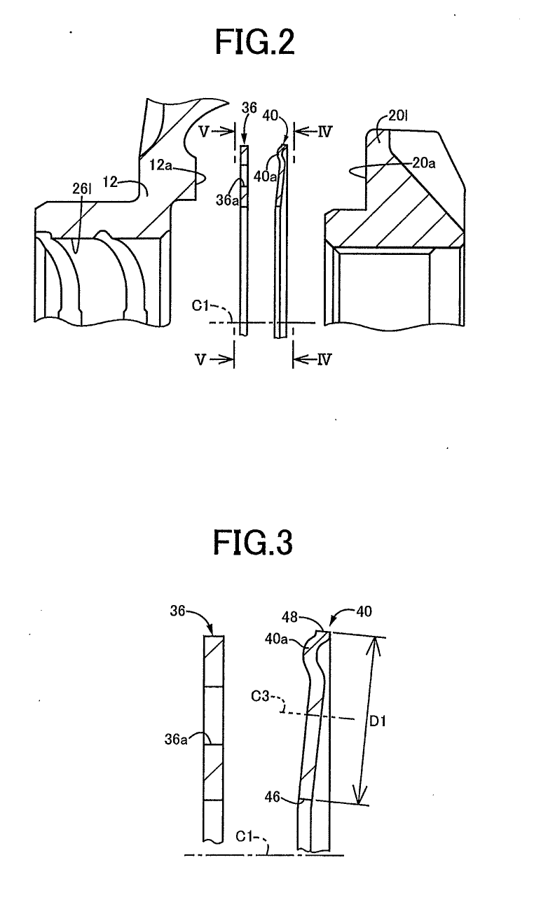

FIG. 2 is an exploded view acquired by dismantling parts in a portion surrounded by a rectangle of the dashed-one dotted line in the vehicle differential gear device of FIG. 1.

FIG. 3 is an enlarged view of a part of a plate washer (shim) and a disk spring of FIG. 2.

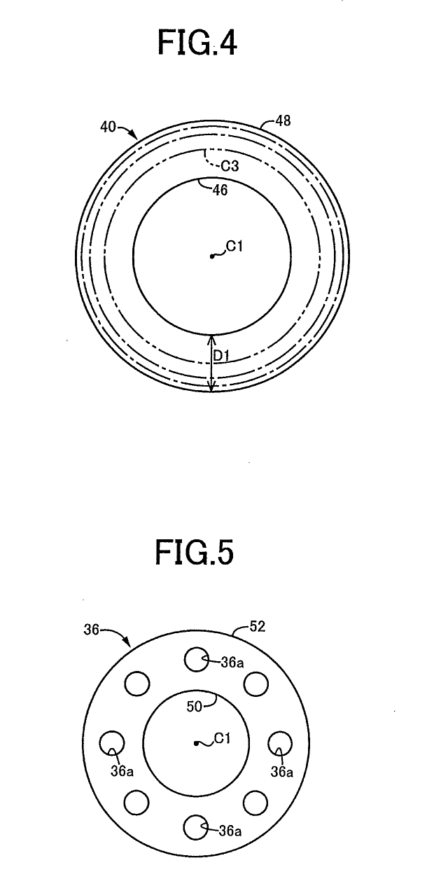

FIG. 4 is a view taken along the line IV-IV of FIG. 2.

FIG. 5 is a view taken along the line V-V of FIG. 2.

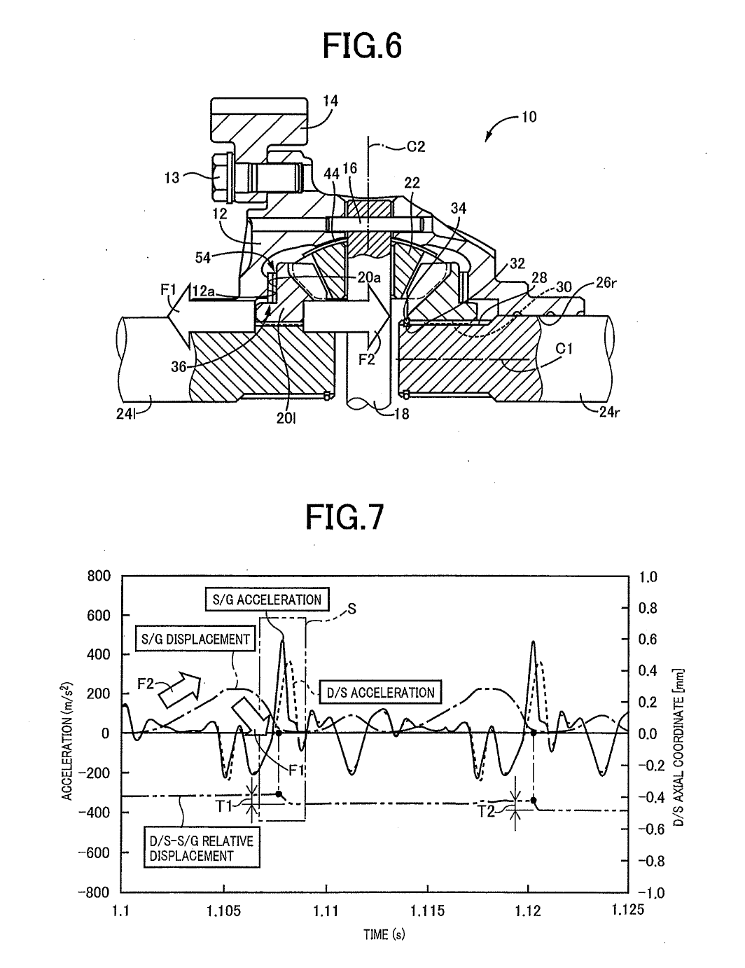

FIG. 6 is a diagram of the vehicle differential gear device using a disk spring disposed on the vehicle differential gear device of FIG. 1 instead of a conventional disk spring without the collision shock-absorbing portion, when a large impulsive torque is transmitted from the pinion gear to the side gear, causing a collision between the side gear and the differential case via the disk spring and the plate washer.

FIG. 7 is a CAE (computer aided engineering) diagram for explaining displacement of the side gear during rotation of the side gear, acceleration of the side gear, acceleration of the axle, relative displacement between the axle and the side gear, etc. in the vehicle differential gear device of FIG. 6 i.e. a simulation analysis diagram using a CAD data.

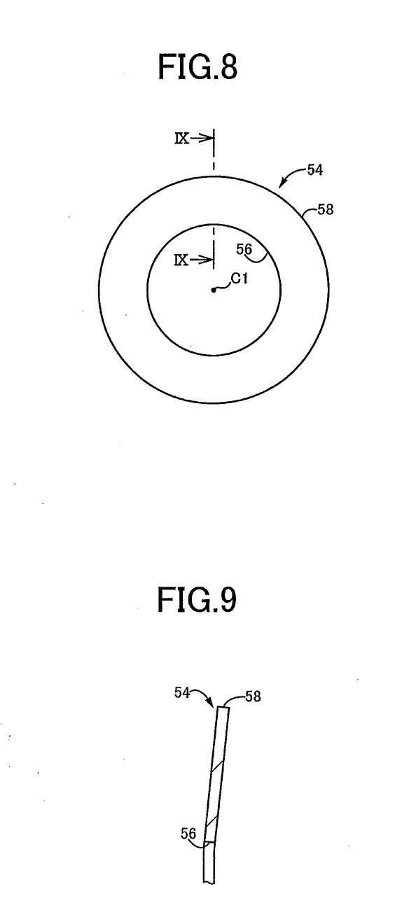

FIG. 8 is a front view of a disk spring without the collision shock-absorbing portion disposed on the conventional vehicle differential gear device.

FIG. 9 is a cross sectional view taken along the line IX-IX of FIG. 8.

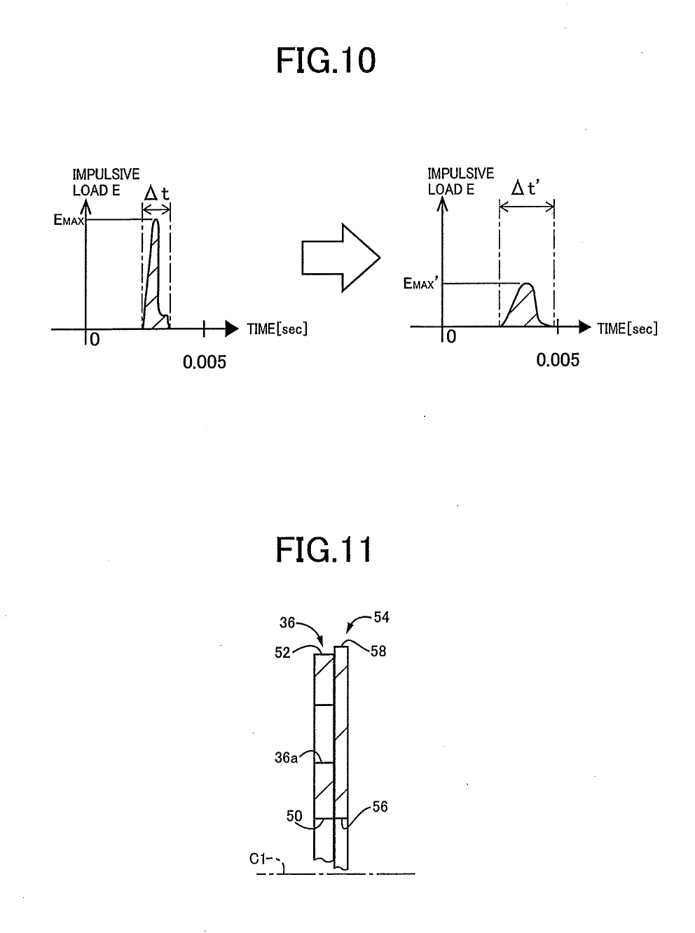

FIG. 10 is a diagram of the magnitude of the impulsive load when the side gear collides with the differential case due to the transmission of the large impulsive torque from the pinion gear to the side gear in the vehicle differential gear device of FIG. 1, and a left graph of FIG. 10 represents the case of using the conventional disk spring described in FIGS. 8 and 9, while a right graph of FIG. 10 represents the case of using the disk spring disposed with the collision shock-absorbing portion described in FIGS. 3 and 4.

FIG. 11 is a diagram for explaining a state of the conventional disk spring described in FIGS. 8 and 9 when the transmission of the large impulsive torque from the pinion gear to the side gear causes the side gear to collide with the differential case.

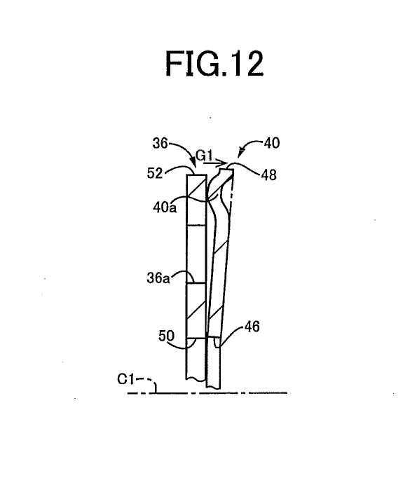

FIG. 12 is a diagram for explaining a state of the disk spring disposed with the collision shock-absorbing portion described in FIGS. 3 and 4 when the transmission of the large impulsive torque from the pinion gear to the side gear causes the side gear to collide with the differential case.

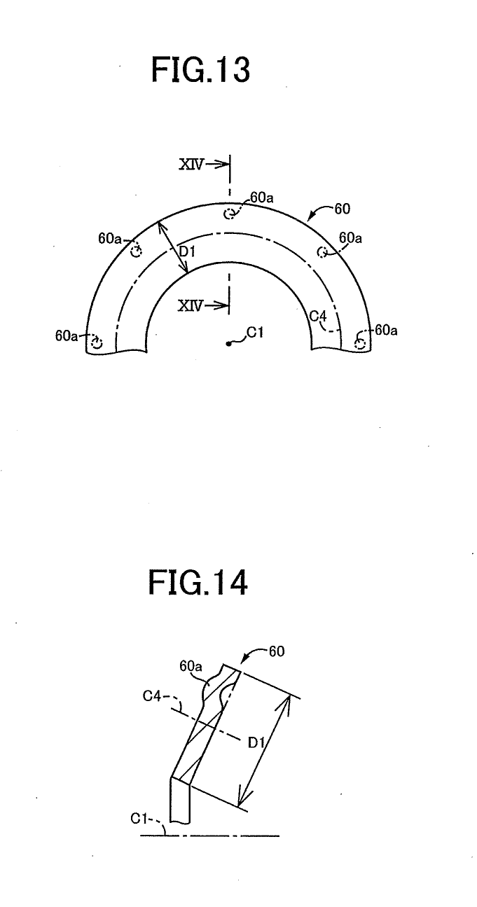

FIG. 13 is a diagram of a part of the disk spring in another example of the present invention.

FIG. 14 is a cross sectional view taken along the line XIV-XIV of FIG. 13.

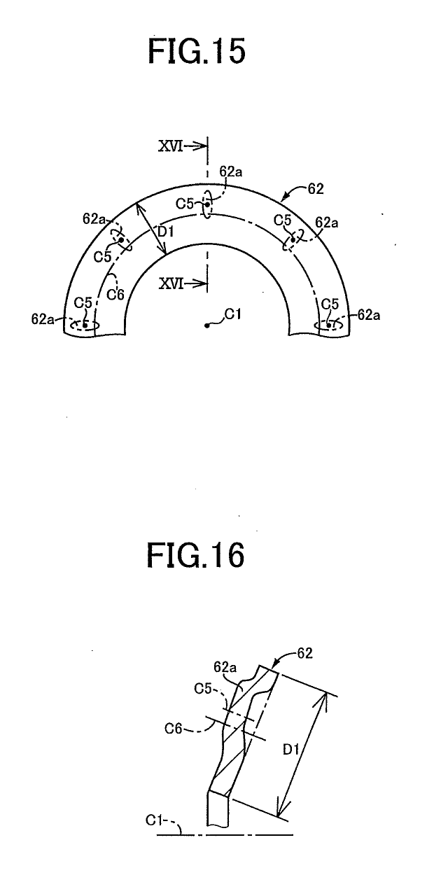

FIG. 15 is a front view of a part of the disk spring in another example of the present invention.

FIG. 16 is a cross sectional view taken along the line XVI-XVI of FIG. 15.

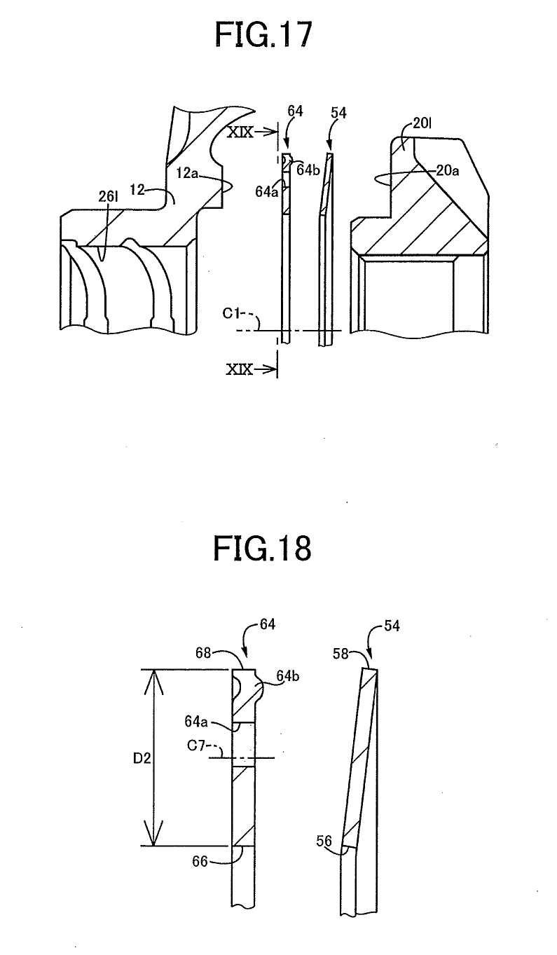

FIG. 17 is a diagram of a state acquired by dismantling the disk spring and the plate washer (shim) disposed on the vehicle differential gear device in another example of the present invention.

FIG. 18 is an enlarged view of a part of a disk spring and a plate washer of FIG. 17.

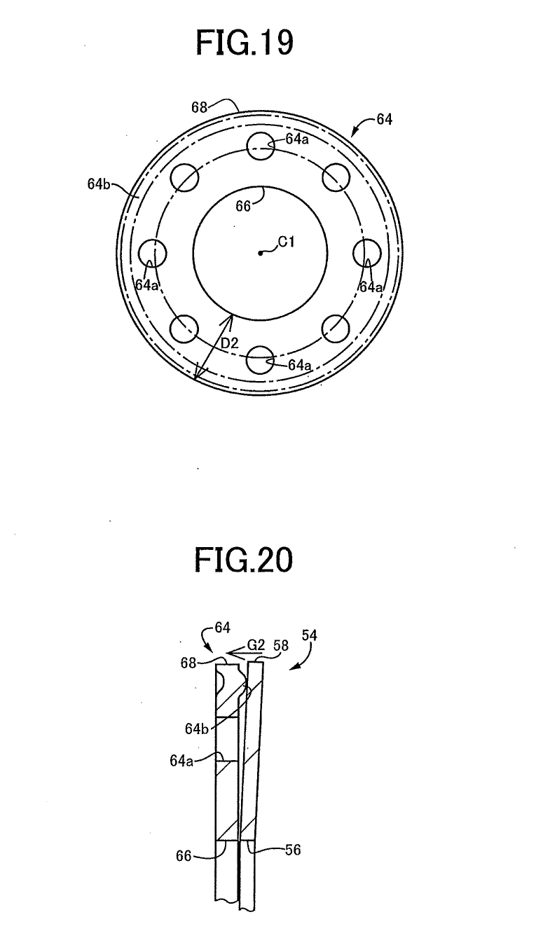

FIG. 19 is a view taken along the line XIX-XIX of FIG. 17.

FIG. 20 is a diagram for explaining a state of the disk spring and the plate washer described in FIGS. 17 and 18 when the transmission of the large impulsive torque from the pinion gear to the side gear causes the side gear to collide with the differential case.

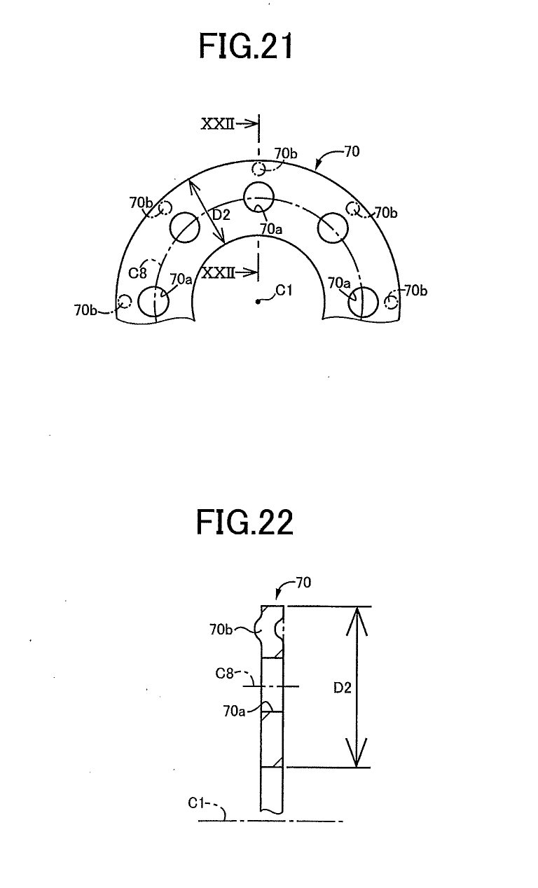

FIG. 21 is a front view of a part of the plate washer (shim) in another example of the present invention.

FIG. 22 is a cross sectional view taken along the line XXII-XXII of FIG. 21.

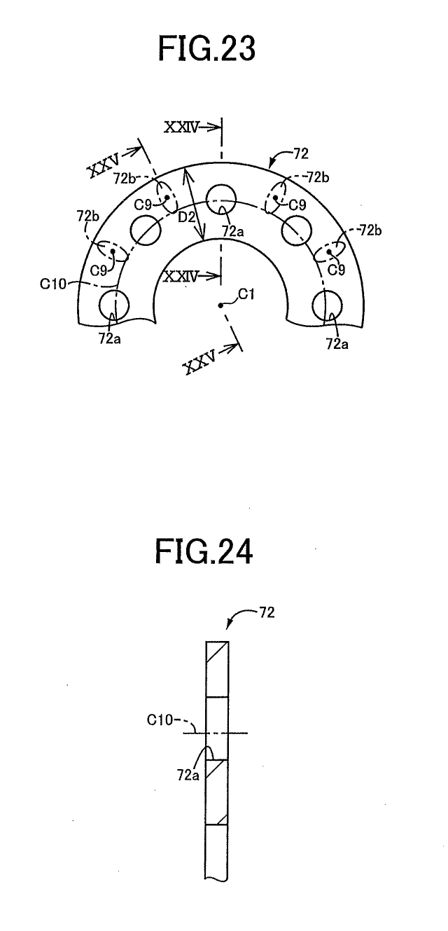

FIG. 23 is a front view of a part of the plate washer (shim) in another example of the present invention.

FIG. 24 is a cross sectional view taken along the line XXIV-XXIV of FIG. 23.

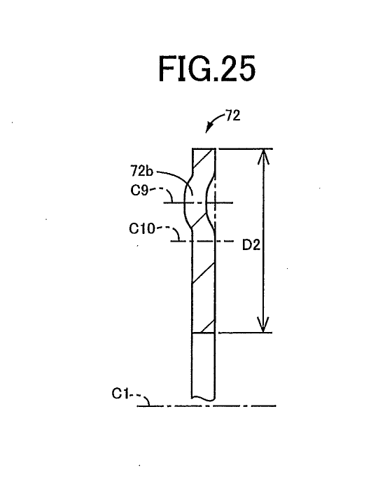

FIG. 25 is a cross sectional view taken along the line XXV-XXV of FIG. 23.

### MODE FOR CARRYING OUT THE INVENTION

An example of the present invention will now be described in detail with reference to the drawings. In the following example, the figures are simplified or deformed as needed to facilitate understanding and portions are not necessarily precisely depicted in terms of dimension ratio, shape, etc. of portions.

### First Example

FIG. 1 is a diagram for explaining a vehicle differential gear device (differential device) 10 to which the present invention is preferably applied, and is a cross-sectional view acquired by cutting on a plane including a rotation axial center (first axial center) C1 of axles (drive shafts) 241 and 24r as well as an axial center (second axial center) C2 of a pinion shaft (pinion shaft) 18 orthogonal thereto. As depicted in FIG. 1, the vehicle differential gear device 10 includes: a differential case 12 made of, for example, a cast iron or a powder alloy, rotatably supported around the rotation axial center C1 via a pair of roller bearings by a housing not depicted; a large-diameter ring gear 14 fixed to an outer circumferential portion of the differential case 12 by a fastener 13 such as a bolt so that power is input from a drive source such as an engine or an electric motor; the pinion shaft 18 supported at both end portions by the differential case 12 and fixed to the differential case 12 by a knock-pin 16 in an orientation in the axial center C2 direction orthogonal to the rotation axial center C1 of the differential case 12; a pair of side gears 201, 20r facing each other across the pinion shaft 18 and supported rotatably (rotatably around its own axis) around the rotation axial center C1 by the differential case 12; and a pair of pinion gears (pinions) 22 penetrated by the pinion shaft 18 and supported rotatably (rotatably around its own axis) by the pinion shaft 18 to respectively mesh with a pair of the side gears 201, 20r between the side gears 201, 20r.

The differential case 12 is disposed with a pair of left and right through-holes 261, 26r rotatably supporting the axles 241 and 24r (only the axle 24r corresponding to a right wheel is depicted in FIG. 1) respectively coupled via joints CP such as constant velocity universal joints to a pair of left and right drive wheels Wl and Wr such as a pair of left and right front or rear wheels of a vehicle. The pair of the side gears 201, 20r and the pair of the axles 241 and 24r non-rotatably fit therein have the same configurations on the left and right sides and, therefore, the configuration of the side gear 20r and the axle 24r on the right side will hereinafter be described as a representative of the configurations.

The axle 24r has fitting grooves (spline grooves) 28 formed on an outer circumferential surface of an end portion while the side gear 20r has fitting teeth (spline teeth) 30 formed on an inner circumferential surface to mesh with the fitting grooves 28, and the axle 24r inserted in the through-hole 26r is fit in such that the fitting teeth 30 on the inner circumferential surface of the side gear 20r and the fitting grooves 28 are meshed with each other, and is therefore relatively non-rotatable around the rotation axial center C1 common with the side gear 20r and relatively movable in the rotation axial center C1 direction such that the axle 24r is integrally rotated with the side gear 20r. The axle 24r has an annular groove 32 formed on an outer circumferential portion of an axial end for allowing a snap ring 34 to be fit therein and, when the snap ring 34 fit into the annular groove 32 is brought into contact with an end surface of the side gear 20r closer to the pinion shaft 18 while being brought into contact with a side wall in the annular groove 32 of the axle 24r, the movement of the side gear 20r and the axle 24r is suppressed in the rotation axial center C1 direction and the axle 24r is prevented from slipping out from the side gear 20r.

The vehicle differential gear device 10 has a pair of annular plate washers (shims) 36, 38 and a pair of annular disk springs 40, 42 pressurized in the rotation axial center C1 direction, which are overlapped with each other and inserted respectively between back surfaces 20a that are end surfaces of a pair of the side gears 201, 20r closer to the drive wheels Wl and Wr and receiving surfaces 12a that are inside opening edge portions of the through-holes 261, 26r of the differential case 12 receiving and supporting the back surfaces 20a, so that the side gears 201, 20r are biased in the direction toward the pinion gears 22. A convex disk-shaped spherical washer 44 in a partially spherical shape having a hole allowing passage of the pinion shaft 18 at the center is inserted with the pinion shaft 18 penetrating therethrough between each of outer circumferential end surfaces (back surfaces) of the pair of the pinion gears 22 and an inner wall surface of the differential case 12. The plate washers 36, 38 and the spherical washers 44 are made of an abrasion-resistant metal, for example, a lead-based or Sn-based bearing metal, or a metal acquired by giving a spring property to the alloy as needed. The plate washer 36 and the disk spring 40 have the same configurations as the plate washer 38 and the disk spring 42, respectively, in the vehicle differential gear device 10 depicted in FIG. 1 and, therefore, the configurations of the plate washer 36 and the disk spring 40 will hereinafter be described as a representative of the configurations.

As depicted in FIGS. 2 and 3, the annular plate washer 36 and the annular disk spring 40 are inserted between the back surface 20a of the side gear 201 and the receiving surface 12a of the differential case 12 in a mutually overlapped manner and are arranged in order of the disk spring 40 and the plate washer 36 from the side closer to the side gear 201.

The disk spring 40 forms an annular shape with an inner circumferential circle 46 and an outer circumferential circle 48 having respective center positions located at the same position on the rotation axial center C1 as depicted in FIG. 4 and is formed into a conical shape between the inner circumferential circle 46 and the outer circumferential circle 48. As depicted in FIGS. 2 to 4, the disk spring 40 has an annular convex portion (collision shock-absorbing portion) 40a bent by pressing, for example, and projected continuously in the circumferential direction of the disk spring 40. The disk spring 40 is manufactured by stamping and press-forming from a spring plate material, for example. As depicted in FIGS. 2 and 3, the convex portion 40a formed on the disk spring 40 has a tip portion of the convex portion 40a projected on the side closer to the plate washer 36 in the rotation axial center C1 direction. As depicted in FIGS. 3 and 4, the convex portion 40a is disposed at a radially outside position relative to an intermediate position C3 of a radial width D1 of the disk spring 40.

The plate washer 36 forms an annular shape with an inner circumferential circle 50 and an outer circumferential circle 52 having respective center positions located at the same position on the rotation axial center C1 as depicted in FIG. 5 and the plate washer 36 is disposed with oil holes 36a for lubrication formed to penetrate at a plurality of positions (in this example, eight positions) at regular intervals in a circumferential direction of the plate washer 36.

FIG. 6 is a diagram of the vehicle differential gear device 10 using instead of the disk spring 40 a conventional disk spring 54 described later with reference to FIGS. 8 and 9, i.e., a disk spring that is the disk spring 40 without the convex portion 40a, when a large impulsive torque is transmitted from the pinion gear 22 to the side gear 201, causing a collision between the back surface 20a of the side gear 201 and the differential case 12 via the disk spring 54 and the plate washer 36. FIG. 7 is a diagram of displacement of the side gear 201 during rotation of the side gear 201 (S/G displacement of FIG. 7), acceleration of the side gear 201 (S/G acceleration of FIG. 7), acceleration of the axle 241 (D/S acceleration of FIG. 7), relative displacement between the axle 241 and the side gear 201 (D/S-S/G relative displacement of FIG. 7), etc. in the vehicle differential gear device 10 of FIG. 6. In FIG. 7, the S/G acceleration is indicated by a solid line; the D/S acceleration is indicated by a broken line; the S/G displacement is indicated by a dashed-dotted line; and the D/S-S/G relative displacement is indicated by a dashed-two dotted line. The conventional disk spring 54 forms an annular shape with an inner circumferential circle 56 and an outer circumferential circle 58 having respective center positions located at the same position on the rotation axial center C1 as depicted in FIG. 8 and is formed into a conical shape between the inner circumferential circle 56 and the outer circumferential circle 58. The disk spring 54 is manufactured by stamping and press-forming from a spring plate material as is the case with the disk spring 40.

As depicted in FIG. 6, when a large impulsive torque is transmitted from the pinion gear 22 to the side gear 201, a thrust force generated based on teeth surfaces thereof moves both the side gear 201 and the axle 241 in a D/S direction, i.e., an arrow F1 direction, causing a collision between the back surface 20a of the side gear 201 and the differential case 12 via the disk spring 54 and the plate washer 36, and an impulsive load E due to the collision generates a slip-out load in the axle 241. Since a value of the relative displacement between D/S and S/G is sharply reduced due to this slip-out load in a region S surrounded by a rectangle of the dashed-two dotted line of FIG. 7, it is understood that a gap T1 is generated in a slip-out direction between the axle 241 and the side gear 201, i.e., the axle 241 slips out from the side gear 201. Also at 1.12 (s) of FIG. 7, a gap T2 is generated in the slip-out direction between the axle 241 and the side gear 201. As depicted in FIG. 6, when a large impulsive torque is transmitted from the pinion gear 22 to the side gear 201, a collision occurs between the side gear 201 and the pinion gear 22, and the collision generates a slip-in load in a differential center direction, i.e., an arrow F2 direction, in the axle 241. The differential center direction is a direction approaching the center of the differential case 12, i.e., the axial center C2, in the rotation axial center C1 direction, and the D/S direction is a direction moving away from the axial center C2, i.e., a direction approaching the axle 241, in the rotation axial center C1 direction. The region S of FIG. 7 is a region representative of a state in which the transmission of the large impulsive torque from the pinion gear 22 to the side gear 201 causes the side gear 201 to collide with the differential case 12 and the impulsive force of the collision progresses the slip-out of the axle 241 from the side gear 201.

The slip-out preventing action of the disk spring 40 for the axle 241 in the vehicle differential gear device 10 of this example will hereinafter be described with reference to FIGS. 10, 11, and 12. FIG. 10 is a diagram of the magnitude of the impulsive load E when the side gear 201 collides with the differential case 12 due to the transmission of the large impulsive torque from the pinion gear 22 to the side gear 201 in the vehicle differential gear device 10, and a left graph of FIG. 10 represents the case of using the vehicle differential gear device 10 using the conventional disk spring 54 described above, while a right graph of FIG. 10 represents the case of using the vehicle differential gear device 10 using the disk spring 40 disposed with the convex portion 40a. On the left and right graphs of FIG. 10, collision energy of the collision of the side gear 201 with the differential case 12 is the same. FIGS. 11 and 12 are diagrams for explaining a state of the conventional disk spring 54 and a state of the disk spring 40 having the convex portion 40a of this example when the transmission of the large impulsive torque from the pinion gear 22 to the side gear 201 causes the side gear 201 to collide with the differential case 12.

When the transmission of the large impulsive torque from the pinion gear 22 to the side gear 201 causes the side gear 201 to collide with the differential case 12 in the vehicle differential gear device 10 using the conventional disk spring 54, since the conventional disk spring 54 has an outer circumferential portion of the disk spring 54 almost completely collapsed as depicted in FIG. 11 in the direction approaching the plate washer 36 in the rotation axial center C1 direction, the impulsive force is transmitted in a relatively short time. Therefore, in the vehicle differential gear device 10 using the conventional disk spring 54, a collision time Δt′ of the collision of the side gear 201 with the differential case 12 is relatively short as depicted in FIG. 10, making the impulsive load E, i.e., a maximum value E_{MAX} of the impulsive load E, relatively larger, and the impulsive load E causes the axle 241 to slip out from the side gear 201.

When the transmission of the large impulsive torque from the pinion gear 22 to the side gear 201 causes the side gear 201 to collide with the differential case 12 in the vehicle differential gear device 10 using the disk spring 40 disposed with the convex portion 40a, the tip portion of the convex portion 40a elastically deforms in an arrow G1 direction depicted in FIG. 12, making a collision time Δt′ relatively long. In particular, in the vehicle differential gear device 10 using the disk spring 40 disposed with the convex portion 40a, when the transmission of the large impulsive torque from the pinion gear 22 to the side gear 201 moves the side gear 201 in the direction approaching the differential case 12 and the side gear 201 elastically deforms the disk spring 40, the tip portion of the convex portion 40a elastically deforms in the arrow G1 direction depicted in FIG. 12 after the disk spring 40 starts deforming elastically and, therefore, the convex portion 40a causes a force to act in a direction separating the side gear 201 and the differential case 12 from each other, resulting in the relatively long collision time Δt′ of the collision of the side gear 201 with the differential case 12. Thus, as depicted in FIG. 10, the collision time Δt′ of the collision of the side gear 201 with the differential case 12 becomes longer than the collision time Δt when the conventional disk spring 54 is used and this preferably makes a maximum value E_{MAX}′ of the impulsive load E smaller than the maximum value E_{MAX} of the impulsive load E in the case of using the conventional disk spring 54 and, as a result, the axle 241 is preferably prevented from slipping out from the side gear 201. In other words, when the side gear 201 collides with the differential case 12, the convex portion 40a of the disk spring 40 acts as a collision shock-absorbing portion alleviating the collision load E of the collision.

As described above, the vehicle differential gear device 10 of this example includes the differential case 12, the side gear 201 rotatably supported in the differential case 12, the axle 241 engaged with the side gear 201 as a separate body different from the side gear 201, the disk spring 40 disposed between the receiving surface 12a of the differential case 12 and the back surface 20a of the side gear 201, and the convex portion 40a of the disk spring 40 acting as the collision shock-absorbing portion between the side gear 201 and the differential case 12 and, when the side gear 201 moves in the direction approaching the differential case 12 and the side gear 201 elastically deforms the disk spring 40, the convex portion 40a of the disk spring 40 causes a force to act in a direction separating the side gear 201 and the differential case 12 from each other after the disk spring 40 starts deforming. Therefore, even if a large impulsive torque is input from the pinion gear 22 to the side gear 201 and the side gear 201 collides with the differential case 12 via the disk spring 40, the convex portion 40a of the disk spring 40 causes a force to act in a direction separating the side gear 201 and the differential case 12 from each other after the start of deformation of the disk spring 40 so that the impulsive load E of the collision is alleviated and, thus, the inertia of the axle 241 moving together with the side gear 201 is reduced to preferably prevent the possibility that the axle 241 slips out from the side gear 201 and the possibility that the snap ring 34 drops off.

According to the vehicle differential gear device 10 of this example, the annular disk spring 40 and the annular plate washer 36 in a pressurized state are overlapped and inserted between the back surface 20a of the side gear 201 and the receiving surface 12a of the differential case 12 receiving the back surface 20a of the side gear 201, and the disk spring 40 is disposed with the convex portion 40a acting as the collision shock-absorbing portion alleviating the collision load E between the differential case 12 and the side gear 201 in the rotation axial center C1 direction of the side gear 201. Therefore, even if a large impulsive torque is input from the pinion gear 22 to the side gear 201 and the side gear 201 collides with the differential case 12 via the disk spring 40 and the plate washer 36, the convex portion 40a disposed on the disk spring 40 alleviates the impulsive load E from the collision and, thus, the inertia of the axle 241 moving together with the side gear 201 is reduced to preferably prevent the possibility that the axle 241 slips out from the side gear 201 and the possibility that the snap ring 34 drops off.

According to the vehicle differential gear device 10 of this example, when the side gear 201 collides with the differential case 12 via the disk spring 40 and the plate washer 36, the convex portion 40a formed on the disk spring 40 elastically deforms and makes the collision time Δt′ at the collision relatively longer as compared to the case of using the conventional disk spring 54 without the convex portion 40a and, therefore, the maximum value E_{MAX}′ of the impulsive load E of the collision is reduced as compared to the conventional case.

According to the vehicle differential gear device 10 of this example, the convex portion 40a is disposed at a radially outside position relative to the intermediate position C3 of the radial width D of the disk spring 40. Therefore, since the convex portion 40a elastically deforms after the disk spring 40 collapses because the convex portion 40a is disposed outside the intermediate position C3 of the radial width D1 of the disk spring 40, the impulsive load E is alleviated at the collision between the differential case 12 and the side gear 201 while maintaining a plate spring function of the disk spring 40, and the axle 241 is restrained from slipping out from the side gear 201.

### Second Example

Another example of the present invention will be described. In the following description, the portions mutually common to the examples are denoted by the same reference numerals and will not be described.

A vehicle differential gear device of this example has substantially the same configuration as compared to the vehicle differential gear device 10 of the first example described above except that the shape of a convex portion (collision shock-absorbing portion) 60a of a disk spring 60 is different from the shape of the convex portion 40a of the disk spring 40 of the first example. In other words, although the convex portion 60a of the disk spring 60 is substantially the same as the convex portion 40a of the disk spring 40 of the first example except that the shape is different and, when the side gear 201 collides with the differential case 12, the convex portion 60a acts as the collision shock-absorbing portion alleviating the collision load E of the collision.

As depicted in FIGS. 13 and 14, the disk spring 60 has the circular convex portions 60a projected at a plurality of positions (in this example, eight positions) at regular intervals in a circumferential direction of the disk spring 60 by press-forming, for example. The convex portions 60a formed on the disk spring 60 have tip portions of the convex portions 60a projected on the side closer to the plate washer 36 in the rotation axial center C1 direction as is the case with the convex portion 40a of the disk spring of the first example. As is the case with the convex portion 40a of the disk spring 40 of the first example, the convex portion 60a is disposed at a radially outside position relative to an intermediate position C4 of the radial width D1 of the disk spring 60.

### Third Example

A vehicle differential gear device of this example has substantially the same configuration as compared to the vehicle differential gear device 10 of the first example described above except that the shape of a convex portion (collision shock-absorbing portion) 62a of a disk spring 62 is different from the shape of the convex portion 40a of the disk spring 40 of the first example. In other words, although the convex portion 62a of the disk spring 62 is substantially the same as the convex portion 40a of the disk spring 40 of the first example except that the shape is different and, when the side gear 201, collides with the differential case 12, the convex portion 60a acts as the collision shock-absorbing portion alleviating the collision load E of the collision.

As depicted in FIGS. 15 and 16, the disk spring 62 has the elliptical convex portions 62a projected at a plurality of positions (in this example, eight positions) at regular intervals in a circumferential direction of the disk spring 62 by press-forming, for example. The convex portions 62a formed on the disk spring 62 have tip portions of the convex portions 60a projected on the side closer to the plate washer 36 in the rotation axial center C1 direction as is the case with the convex portion 40a of the disk spring of the first example. As depicted in FIG. 15, the convex portions 62a are disposed such that intermediate positions C5 of the convex portions 62a are located at radially outside positions relative to an intermediate position C6 of the width D1 of the disk spring 62 in the radial direction of the disk spring 62.

### Fourth Embodiment

A vehicle differential gear device of this example has substantially the same configuration as compared to the vehicle differential gear device 10 of the first example described above except that the disk spring 40 disposed with the convex portion 40a is replaced with the conventional disk spring 54 and that a plate washer (shim) 64 is different from the plate washer 36 of the first example.

As depicted in FIGS. 17 and 18, the plate washer 64 and the disk spring 54 are overlapped with each other and inserted between the back surface 20a of the side gear 201 and the receiving surface 12a of the differential case 12 and are arranged in order of the disk spring 54 and the plate washer 64 from the side closer to the side gear 201.

The plate washer 64 forms an annular shape with an inner circumferential circle 66 and an outer circumferential circle 68 having respective center positions located at the same position on the rotation axial center C1 as depicted in FIG. 19 and the plate washer 64 is disposed with oil holes 64a for lubrication formed to penetrate at a plurality of positions (in this example, eight positions) at regular intervals in a circumferential direction of the plate washer 64. As depicted in FIGS. 17 to 19, the plate washer 64 has an annular convex portion (collision shock-absorbing portion) 64b bent by pressing, for example, and projected continuously in the circumferential direction of the plate washer 64. As depicted in FIGS. 17 and 18, the convex portion 64b formed on the plate washer 64 has a tip portion of the convex portion 64b projected on the side closer to the disk spring 54 in the rotation axial center C1 direction. As depicted in FIGS. 18 and 19, the convex portion 64b is disposed at a radially outside position relative to an intermediate position C7 of the radial width D2 of the plate washer 64.

When the transmission of the large impulsive torque from the pinion gear 22 to the side gear 201 causes the side gear 201 to collide with the differential case 12 in the vehicle differential gear device including the plate washer 64 and the disk spring 54 configured as above, the tip portion of the convex portion 64b of the plate washer 64 elastically deforms in an arrow G2 direction depicted in FIG. 20, making a collision time relatively long as is the case with the collision time Δt′ depicted in FIG. 10 of the first example. In particular, when the transmission of the large impulsive torque from the pinion gear 22 to the side gear 201 moves the side gear 201 in the direction approaching the differential case 12 and the side gear 201 elastically deforms the disk spring 54, the tip portion of the convex portion 64b of the plate washer 64 elastically deforms in the arrow G2 direction depicted in FIG. 20 after the disk spring 54 starts elastically deforming and, therefore, the convex portion 64b causes a force to act in a direction separating the side gear 201 and the differential case 12 from each other, resulting in a relatively long collision time of the collision of the side gear 201 with the differential case 12 as is the case with the collision time Δt′ depicted in FIG. 10 of the first example. Thus, as is the case with the maximum value E_{MAX}′ of the impulsive load E depicted in FIG. 10 of the first example, the maximum value of the impulsive load E is preferably made smaller and, as a result, the axle 241 is preferably prevented from slipping out from the side gear 201. In other words, when the side gear 201 collides with the differential case 12, the convex portion 64b of the plate washer 64 acts as a collision shock-absorbing portion alleviating the collision load E of the collision.

As described above, the vehicle differential gear device of this example includes the differential case 12, the side gear 201 rotatably supported in the differential case 12, the axle 241 engaged with the side gear 201 as a separate body different from the side gear 201, the disk spring 54 and the plate washer 64 disposed between the receiving surface 12a of the differential case 12 and the back surface 20a of the side gear 201, and the convex portion 64b of the plate washer 64 acting as the collision shock-absorbing portion between the side gear 201 and the differential case 12 and, when the side gear 201 moves in the direction approaching the differential case 12 and the side gear 201 elastically deforms the disk spring 54, the convex portion 64b of the disk spring 64 causes a force to act in a direction separating the side gear 201 and the differential case 12 from each other after the disk spring 54 starts deforming. Therefore, even if a large impulsive torque is input from the pinion gear 22 to the side gear 201 and the side gear 201 collides with the differential case 12 via the disk spring 54 and the plate washer 64, the convex portion 64b of the plate washer 64 causes a force to act in a direction separating the side gear 201 and the differential case 12 from each other after the start of deformation of the disk spring 54 so that the impulsive load E of the collision is alleviated and, thus, the inertia of the axle 241 moving together with the side gear 201 is reduced to preferably prevent the possibility that the axle 241 slips out from the side gear 201 and the possibility that the snap ring 34 drops off.

According to the vehicle differential gear device of this example, the annular disk spring 54 and the annular plate washer 64 in a pressurized state are overlapped and inserted between the back surface 20a of the side gear 201 and the receiving surface 12a of the differential case 12 receiving the back surface 20a of the side gear 201, and the plate washer 64 is disposed with the convex portion 64b acting as the collision shock-absorbing portion alleviating the collision load E between the differential case 12 and the side gear 201 in the rotation axial center C1 direction of the side gear 201. Therefore, even if a large impulsive torque is input from the pinion gear 22 to the side gear 201 and the side gear 201 collides with the differential case 12 via the disk spring 54 and the plate washer 64, the convex portion 64b disposed on the plate washer 64 alleviates the impulsive load E from the collision and, thus, the inertia of the axle 241 moving together with the side gear 201 is reduced to preferably prevent the possibility that the axle 241 slips out from the side gear 201 and the possibility that the snap ring 34 drops off.

According to the vehicle differential gear device of this example, when the side gear 201 collides with the differential case 12 via the disk spring 54 and the plate washer 64, the convex portion 64b formed on the plate washer 64 elastically deforms and makes the collision time at the collision relatively longer as compared to the case of using the conventional disk spring 54 without the convex portion 40a and the conventional plate washer 36 without the convex portion 64a and, therefore, the maximum value of the impulsive load E of the collision is reduced as compared to the conventional case.

According to the vehicle differential gear device of this example, the convex portion 64b is disposed at a radially outside position relative to the intermediate position C7 of the radial width D2 of the plate washer 64. Therefore, since the convex portion 64b of the plate washer 64 elastically deforms after the disk spring 54 collapses because the convex portion 64b is disposed outside the intermediate position C7 of the radial width D2 of the plate washer 64, the impulsive load E is alleviated at the collision between the differential case 12 and the side gear 201 while maintaining a plate spring function of the disk spring 54, and the axle 241 is restrained from slipping out from the side gear 201.

### Fifth Example

A vehicle differential gear device of this example has substantially the same configuration as compared to the vehicle differential gear device of the fourth example described above except that the shape of a convex portion (collision shock-absorbing portion) 70b of a plate washer 70 is different from the shape of the convex portion 64b of the plate washer 64 of the fourth example. In other words, although the convex portion 70b of the plate washer 70 is substantially the same as the convex portion 64b of the plate washer 64 of the fourth example except that the shape is different and, when the side gear 201 collides with the differential case 12, the convex portion 70b acts as the collision shock-absorbing portion alleviating the collision load E of the collision.

As depicted in FIGS. 21 and 22, the plate washer 70 is disposed with oil holes 70a for lubrication formed to penetrate at a plurality of positions (in this example, eight positions) at regular intervals in a circumferential direction of the plate washer 70, and the circular convex portions 70b projected at a plurality of positions (in this example, eight positions) at regular intervals in a circumferential direction of the plate washer 70 by press-forming, for example. The convex portions 70b formed on the plate washer 70 have tip portions of the convex portions 70b projected on the side closer to the disk spring 54 in the rotation axial center C1 direction as is the case with the convex portion 64b of the plate washer 64 of the fourth example. As is the case with the convex portion 64b of the plate washer 64 of the fourth example, the convex portion 70b is disposed at a radially outside position relative to an intermediate position C8 of the radial width D2 of the plate washer 70.

### Sixth Example

A vehicle differential gear device of this example has substantially the same configuration as compared to the vehicle differential gear device of the fourth example described above except that the shape of a convex portion (collision shock-absorbing portion) 72b of a plate washer 72 is different from the shape of the convex portion 64b of the plate washer 64 of the fourth example. In other words, although the convex portion 72b of the plate washer 72 is substantially the same as the convex portion 64b of the plate washer 64 of the fourth example except that the shape is different and, when the side gear 201 collides with the differential case 12, the convex portion 72b acts as the collision shock-absorbing portion alleviating the collision load E of the collision.

As depicted in FIGS. 23 to 25, the plate washer 72 is disposed with oil holes 72a for lubrication formed to penetrate at a plurality of positions (in this example, eight positions) at regular intervals in a circumferential direction of the plate washer 72, and the elliptical convex portions 72b projected at a plurality of positions (in this example, eight positions) at regular intervals in a circumferential direction of the plate washer 72 by press-forming, for example. The convex portions 72b formed on the plate washer 72 have tip portions of the convex portions 72b projected on the side closer to the disk spring 54 in the rotation axial center C1 direction as is the case with the convex portion 64b of the plate washer 64 of the fourth example. As depicted in FIGS. 23 and 25, the convex portions 72b are disposed such that intermediate positions C9 of the convex portions 72b are located at radially outside positions relative to an intermediate position C10 of the width D2 of the plate washer 72 in the radial direction of the plate washer 72.

Although the examples of the present invention have been described in detail with reference to the drawings, the present invention is also applied in other forms.

Although the vehicle differential gear device of the example has the disk springs 40, 44 and the plate washers (shims) 36, 38 respectively overlapped and arranged between the back surfaces 20a of the side gears 201, 20r and the receiving surface 12a of the differential case 12, the plate washers 36, 38 may not necessarily be disposed. If the plate washers 36, 38 are not disposed, the convex portions are formed on the disk springs 40, 44.

Although the vehicle differential gear device of the examples has the disk spring 40, 60, 62 formed with the convex portion 40a, 60a, 62a acting as the collision shock-absorbing portion in the first to third examples or has the plate washer 64, 70, 72 provided with the convex portion 64b, 70b, 72b acting as the collision shock-absorbing portion in the fourth to sixth examples, respectively, for example, both the disk spring 40, 60, 62 and the plate washer 64, 70, 72 may be provided with the convex portions acting as the collision shock-absorbing portion at corresponding positions such that the convex portions come into contact with each other. Alternatively, a concave portion may be formed on one of the surfaces of the disk spring 40, 60, 62 and the plate washer 64, 70, 72 facing the receiving surface 12a of the differential case 12 or the back surface 20a of the side gear 201, 20r, and a convex portion may be formed on the other of the surfaces of the disk spring 40, 60, 62 and the plate washer 64, 70, 72 at a position corresponding to the concave portion such that the convex and concave portions come into contact with each other.

The above description is merely an embodiment and the present invention can be implemented in variously modified and improved forms based on the knowledge of those skilled in the art.

### NOMENCLATURE OF ELEMENTS

10: vehicle differential gear device 12: differential case 12a: receiving surface 20r, 201: side gear 20a: back surface 22: pinion gear (pinion) 24r, 241: axle 40, 60, 62: disk spring 40a, 60a, 62a: convex portion (collision shock-absorbing portion) 64, 70, 72: plate washer (shim) 64b, 70b, 72b: convex portion (collision shock-absorbing portion) C1: rotation axial center (first axial center) C2: axial center (second axial center) E: impulsive load

1. A vehicle differential gear device comprising:
a differential case;
a side gear rotatably supported in the differential case;
a drive shaft engaged with the side gear as a separate body from the side gear;
a disk spring disposed between the differential case and the side gear;
and a collision shock-absorbing portion between the side gear and the differential case,
the side gear moving in a direction approaching the differential case, the side gear elastically deforming the disk spring,
the collision shock-absorbing portion causing a force to act in a direction separating the side gear and the differential case from each other after the disk spring starts deforming.

2. A vehicle differential gear device comprising: a differential case rotationally driven around a first axial center; a pinion rotatably supported around a second axial center orthogonal to the first axial center in the differential case; and a pair of side gears arranged relatively rotatably around the first axial center and across the pinion in the differential case and meshing with the pinion, the vehicle differential gear device distributing a power, which is input from a drive force source to the differential case, to drive wheels via a pair of axles having axial ends non-rotatably fit into the pair of the side gears,
an annular disk spring in a pressurized state, or the annular disk spring in a pressurized state and an annular shim in an overlapped state, being inserted between a back surface of the side gear and a receiving surface of the differential case receiving the back surface of the side gear, at least one of the disk spring and the shim being disposed with a collision shock-absorbing portion alleviating a collision load between the differential case and the side gear in an axial center direction of the side gear.

3. The vehicle differential gear device of claim 1, wherein the collision shock-absorbing portion is a convex portion formed on the disk spring.

4. The vehicle differential gear device of claim 2, wherein the collision shock-absorbing portion is a convex portion formed on the shim.

5. The vehicle differential gear device of claim 1, further comprising
a shim between the disk spring and the differential case, wherein
the collision shock-absorbing portion is a convex portion disposed on the shim.
